(19) United States
(12) Patent Application Publication
(10) Pub. No.: US 2026/0328147 A1
(43) Pub. Date: Oct. 22, 2026

(54) SYSTEM FOR SUPPLYING HYDROGEN TO A TURBINE ENGINE, AND DEVICE FOR REGULATING SUCH A HYDROGEN SUPPLY SYSTEM

(71) Applicant: SAFRAN AIRCRAFT ENGINES, PARIS (FR)

(72) Inventors: Pierre CABRERA, MOISSY-CRAMAYEL (FR); Romain Eric Bernard LE RIBOTER, MOISSY-CRAMAYEL (FR)

(21) Appl. No.: 19/122,075

(22) PCT Filed: Oct. 18, 2023
(86) PCT No.: PCT/FR2023/051632

§ 371 Date: Apr. 17, 2025

(30) Foreign Application Priority Data
Oct. 19, 2022 (FR) FR2210790

(51) Int. Cl. F02C 9/40; B64D 27/10; B64D 37/30; F02C 3/22; F02C 7/22; F23R 3/28

(52) U.S. Cl. CPC F02C 9/40; B64D 27/10; B64D 37/30; F02C 3/22; F02C 7/22; F23R 3/28

(57) ABSTRACT

A device for regulating a hydrogen supply system of a turbine engine comprises a combustion chamber, the hydrogen supply system including, particularly arranged in series, at least: a pressurization member, and a metering member advantageously connected to the combustion chamber, wherein it further includes: a hydrogen accumulator arranged between the pressurization member and the metering member, a first regulator capable of controlling the pressurization member according to a hydrogen pressure in the hydrogen accumulator and a hydrogen pressure setpoint in the hydrogen accumulator, and a second regulator capable of controlling the metering member according to a hydrogen flow rate injected into the combustion chamber and a hydrogen flow rate setpoint to be injected into the combustion chamber.

### TECHNICAL FIELD

The present invention relates, generally, to a hydrogen supply system of a turbine engine, such as an aircraft engine, using hydrogen as fuel. It relates more particularly to a device for regulating a hydrogen supply system of such a turbine engine.

### PRIOR ART

The function of a hydrogen supply system of a turbine engine, more particularly an aircraft engine, is that of supplying a controlled hydrogen flow rate to the injectors located in a combustion chamber of the turbine engine.

The turbine engine hydrogen supply system includes in series, along a hydrogen flow direction, from upstream to downstream:
a liquid hydrogen tank,
a liquid hydrogen pressurization member,
a heating member intended to raise the temperature of the liquid hydrogen so as to allow its evaporation into gaseous hydrogen,
a metering member intended to meter the gaseous hydrogen mass flow rate at the combustion chamber input, and
a shut-off valve.

The shut-off valve is connected to a supply line which is connected to the turbine engine injectors.

To finely meter the hydrogen flow rate injected into the combustion chamber of the turbine engine, laws for regulating the hydrogen supply system of the turbine engine must be determined. This consists of a “multiple inputs, single output” type system, also known as MISO.

In addition, the laws for regulating the system must particularly take into account the constraints linked with a need to ensure a high metering performance level in terms of response time, precision and robustness, while limiting the need for power to be supplied by the pressurization member.

### DISCLOSURE OF THE INVENTION

The invention aims to solve the problems of the prior art by providing a device for regulating a hydrogen supply system of a turbine engine comprising a combustion chamber, the hydrogen supply system including, particularly arranged in series, at least:
a pressurization member, and
a metering member advantageously connected to the combustion chamber,
characterized in that it further includes
a hydrogen accumulator arranged between the pressurization member and the metering member,
a first regulator capable of controlling the pressurization member according to a hydrogen pressure in the hydrogen accumulator and a hydrogen pressure setpoint in the hydrogen accumulator, and
a second regulator capable of controlling the metering member according to a hydrogen flow rate injected into the combustion chamber and a hydrogen flow rate setpoint to be injected into the combustion chamber.

The hydrogen accumulator is used to uncouple the dynamics of the upstream part of the hydrogen supply system from the downstream part of the hydrogen supply system.

It is then possible to uncouple the respective control logics of the upstream part and the downstream part of the turbine engine hydrogen supply system.

According to a preferred feature, the first regulator controls the operation of the pressurization member according to a difference between the hydrogen pressure in the hydrogen accumulator and the hydrogen pressure setpoint in the hydrogen accumulator.

According to a preferred feature, the second regulator controls the operation of the metering member according to a difference between the hydrogen flow rate injected into the combustion chamber and the hydrogen flow rate setpoint to be injected into the combustion chamber.

According to a preferred feature, the regulation device further includes a pressure setpoint processing circuit capable of determining the hydrogen pressure setpoint.

According to a preferred feature, the pressure setpoint processing circuit comprises an input connected to an engine control device of the turbine engine and an output connected to a first subtracter intended to compute the difference between the hydrogen pressure value and the hydrogen pressure setpoint.

According to a preferred feature, the pressure setpoint processing circuit comprises a downstream pressure processing module capable of determining a hydrogen pressure downstream of the metering member.

According to a preferred feature, the downstream pressure processing module determines the hydrogen pressure downstream of the metering member based on the hydrogen flow rate value injected into the combustion chamber and a hydrogen pressure value in the combustion chamber.

According to a preferred feature, the pressure setpoint processing circuit comprises a stabilized setpoint processing module capable of determining a stabilized hydrogen pressure setpoint in the hydrogen accumulator.

According to a preferred feature, the pressure setpoint processing circuit comprises a phase lead determination module capable of defining a compensation of a response time of the first regulator in transient mode.

According to a preferred feature, the metering member carries out sonic and/or subsonic metering, according to the hydrogen pressure setpoint.

The invention also relates to a turbine engine hydrogen supply system, characterized in that it includes a regulation device as described hereinabove.

The invention also relates to a turbine engine including injectors, characterized in that it includes a hydrogen supply system as described hereinabove.

The invention also relates to an aircraft including a turbine engine as described hereinabove.

The turbine engine hydrogen supply system, the turbine engine and the aircraft have similar advantages to those described hereinabove.

### BRIEF DESCRIPTION OF THE DRAWINGS

Further features and advantages will become apparent upon reading the following description of a preferred embodiment, given by way of non-limiting example, described with reference to the figures wherein:

FIG. 1 schematically illustrates a turbine engine hydrogen supply system according to one embodiment of the invention.

FIG. 2 illustrates graphs showing evolutions over time of a hydrogen flow rate at the output of a hydrogen accumulator of the hydrogen supply system according to the invention.

FIG. 3 schematically illustrates a device for regulating the turbine engine hydrogen supply system, according to one embodiment of the invention.

FIG. 4 illustrates a hydrogen pressure setpoint processing circuit in the hydrogen accumulator of the hydrogen supply system according to the invention and,

FIG. 5 illustrates graphs showing an evolution over time of a hydrogen pressure setpoint at the hydrogen accumulator output of the hydrogen supply system, according to one embodiment of the invention.

Identical, similar or equivalent parts of the different figures bear the same numerical references so as to facilitate the transition from one figure to another.

The different parts shown in the figures are not necessarily shown according to a uniform scale, in order to make the figures more readable.

The different possibilities (variants and embodiments) must be understood as not being exclusive of each other and can be combined with each other.

### DETAILED DESCRIPTION OF SOME EMBODIMENTS

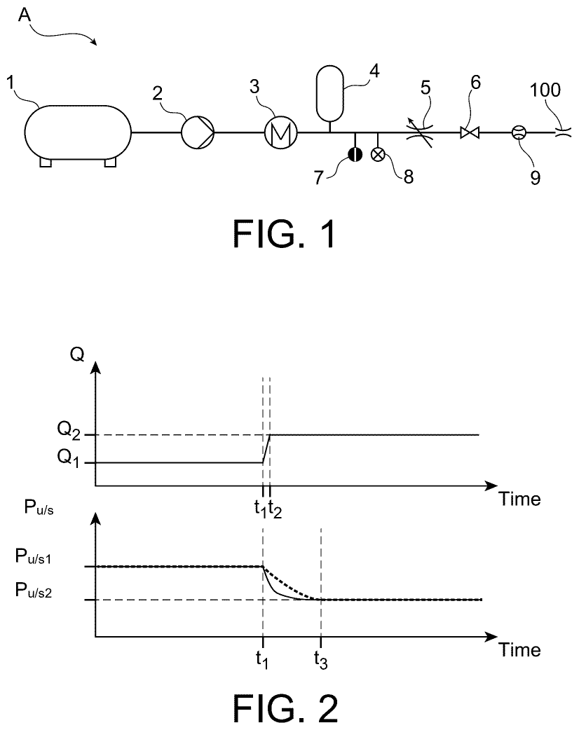

FIG. 1 schematically shows an embodiment of the invention of a turbine engine hydrogen supply system A capable of supplying a controlled hydrogen flow rate to injectors 100 located in a combustion chamber of the turbine engine.

More specifically, the hydrogen supply system A includes, along a hydrogen flow direction, from upstream to downstream, a hydrogen tank 1, particularly wherein hydrogen is in a cryogenic liquid state, in particular at low pressure, for example of an order of magnitude between 2 bar and 3 bar, and at low temperature, for example of an order of magnitude of 10K.

The hydrogen tank 1 is connected to a pressurization member 2 intended to increase the pressure of the hydrogen, particularly liquid hydrogen. The hydrogen pressure rise is performed in such a way as to maintain a hydrogen pressure at injection greater than a pressure Pcc of the turbine engine combustion chamber.

At a given injected hydrogen flow rate, the difference between the output pressure of the pressurization member 2 and the pressure Pcc in the combustion chamber must therefore be greater than the sum of the pressure losses of the different items of equipment of the hydrogen supply system A.

The pressurization member 2 can, for example, be a pump, particularly a centrifugal pump, or several pumps, in particular several centrifugal pumps, in series.

The pressurization member 2 is connected to a heating member 3, intended to increase the temperature of the hydrogen, particularly liquid hydrogen. Such a temperature increase makes it possible to perform evaporation of the hydrogen entering the heating member 3 into gaseous hydrogen, while controlling a range of permissible temperatures for hydrogen combustion.

The heating member 3 can, for example, be an electric exchanger or an exchanger with another heated fluid.

The heating member 3 is connected to a hydrogen accumulator 4, in particular an accumulator of hydrogen in the gaseous state, intended to fulfill a “buffer” function between an upstream part of the hydrogen supply system A arranged upstream of the hydrogen accumulator 4 and a downstream part of the hydrogen supply system A arranged downstream of the hydrogen accumulator 4.

The hydrogen accumulator 4 is connected to a metering member 5 intended to meter a mass flow rate of hydrogen, particularly gaseous hydrogen, at the combustion chamber input.

The metering member 5 can, for example, be a variable cross-section metering valve or a regulator coupled with a sonic throat.

The metering member 5 is connected to a shut-off member 6 intended to allow isolation between the hydrogen supply system A and the turbine engine combustion chamber.

The shut-off member 6 can, for example, be an “ON/OFF” type shut-off valve.

The shut-off member 6 is connected to a supply line connected to the injectors 100 located in the turbine engine combustion chamber. The injectors 100 and the combustion chamber are conventional and are not detailed here.

The hydrogen supply system A further includes several sensors. In particular, the hydrogen supply system A can include:
a hydrogen temperature sensor 7, particularly arranged upstream of the metering member 5, in particular between the hydrogen accumulator 4 and the metering member 5;
a hydrogen pressure sensor 8, particularly arranged upstream of the metering member 5, in particular between the hydrogen accumulator 4 and the metering member 5; and/or
a hydrogen flow rate sensor 9, advantageously located as close as possible to the turbine engine injectors 100, particularly arranged downstream of the shut-off member 6.

The hydrogen flow rate sensor 9 is, for example, a mass flow meter or any other type of sensor making it possible to acquire the information in respect of the flow rate circulating in the hydrogen supply system A.

The hydrogen flow rate sensor 9 therefore makes it possible to measure a hydrogen flow rate supplied to the injectors 100.

According to a first variant, the metering member 5 operates according to the sonic metering principle. In this case, if the relation:

$$\frac{{P}_{d / s}}{{P}_{u / s}} < {( \frac{2}{γ + 1} )}^{\frac{γ}{γ - 1}} \approx 0.5 ( value for hydrogen )$$

where
   P_{u/s} is a hydrogen pressure upstream of the metering member 5,
   P_{d/s} is a hydrogen pressure downstream of the metering member 5,
   γ is an adiabatic index of hydrogen,
is verified, a flow rate downstream of the metering member 5 is given by a relation (1):

$$Q = S \times \frac{{P}_{u / s}}{\sqrt{{T}_{u / s}}} \times \sqrt{\frac{γ}{r \times {( \frac{γ + 1}{2} )}^{\frac{γ + 1}{γ - 1}}}} \qquad ( 1 )$$

where
   Q is a hydrogen flow rate through the metering member 5,
   S is a cross-section of the metering member 5,
   T_{u/s} is a hydrogen temperature upstream of the metering member 5, and
   r is the gas constant of hydrogen.

According to relation (1), the hydrogen flow rate Q, metered through the metering member 5 depends on the variation of the hydrogen temperature T_{u/s} upstream of the metering member 5.

However, due to the slow temperature variation dynamics, particularly of an order of magnitude of several seconds, and a low impact, namely as a square root as shown by relation (1), the hydrogen temperature T_{u/s} upstream of the metering member 5 is considered as interference and is not taken into account as a control parameter of the hydrogen supply system A.

More particularly, the metering member 5 can be embodied according to two possibilities.

According to a first possibility, the metering member 5 is a variable cross-section valve. According to this configuration, to meter a hydrogen flow rate Q through the metering member 5, only the parameters related to the cross-section S of the metering member 5 and to the hydrogen pressure P_{u/s} upstream of the metering member 5 in relation (1) vary. Thus,
The cross-section S of the metering member 5 varies according to a command applied to the variable cross-section valve as the metering member 5; and
The hydrogen pressure P_{u/s} upstream of the variable cross-section valve as the metering member 5 varies according to a command applied to the pressurization member 2, for example by varying a rotational speed of the pump(s) as the pressurization member 2.

According to a second possibility, the metering member 5 is a sonic throat with pressure relief valve. According to this configuration, to meter a hydrogen flow rate Q through the metering member 5, only the parameter related to the hydrogen pressure P_{u/s} upstream of the metering member 5 in relation (1) varies. Thus,
the cross-section S of the metering member 5 is fixed, since the sonic throat as the metering member 5 is of fixed cross-section S;
The pressure relief valve of the metering member 5 regulates a differential pressure ΔPₚᵣᵥ, corresponding to a difference between a hydrogen pressure P_{accu} in the hydrogen accumulator 4 and the hydrogen pressure P_{u/s} upstream of the dosing member 5, particularly according to a command applied to the pressure relief valve; and
The hydrogen pressure P_{accu} in the hydrogen accumulator 4, particularly corresponding to a pressure upstream of the pressure relief valve, varies according to the command applied to the pressurization member 2, for example by varying the rotational speed of the pump(s) as the pressurization member 2.

Thus, the differential pressure ΔPₚᵣᵥ=P_{accu}−P_{u/s} is a head loss regulated by the pressure relief valve of the metering member 5.

According to a second variant, the metering member 5 operates according to the subsonic metering principle. In this case, if the relation:

$$\frac{{P}_{d / s}}{{P}_{u / s}} < {( \frac{2}{γ + 1} )}^{\frac{γ}{γ - 1}} \approx 0.5 ( value for hydrogen )$$

is verified, the flow rate downstream of the metering member 5 is given by a relation (1a):

$$Q = S \times \frac{{P}_{u / s}}{\sqrt{{T}_{u / s}}} \times \sqrt{\frac{γ}{r \times ( \frac{γ + 1}{2} )}} \times \sqrt{{( \frac{{P}_{d / s}}{{P}_{u / s}} )}^{\frac{2}{γ}} - {( \frac{{P}_{d / s}}{{P}_{u / s}} )}^{\frac{γ + 1}{γ}}} \qquad ( 1 a )$$

More particularly, in a similar manner to that described hereinabove, the metering member 5 can be implemented according to two possibilities.

According to the first possibility, the metering member 5 is a variable cross-section valve. According to this configuration, to meter the hydrogen flow rate Q through the metering member 5, only the parameters related to the cross-section S of the metering member 5, to the hydrogen pressure P_{u/s} upstream of the metering member 5 and to the hydrogen pressure P_{d/s} downstream of the metering member 5 in a relation (1a) vary. Thus,
the cross-section S of the metering member 5 varies according to the command applied to the variable cross-section valve as the metering member 5;
the hydrogen pressure P_{u/s} upstream of the variable cross-section valve as the metering member 5 varies according to the command applied to the pressurization member 2, for example by varying the rotational speed of the pump(s) as the pressurizing member 2; and
the hydrogen pressure P_{d/s} downstream of the variable cross-section valve varies according to an evolution of the pressure Pcc in the combustion chamber, for example by varying the rotational speed of the high-pressure compressor.

According to a second possibility, the metering member 5 is a subsonic throat with pressure relief valve. According to this configuration, to meter a hydrogen flow rate Q through the metering member 5, only the parameters P_{u/s} and P_{d/s} of the formula (1a) vary. Thus,
the cross-section S of the metering member 5 is fixed, since the subsonic throat as the metering member 5 is of fixed cross-section S;
   the pressure relief valve of the metering member 5 regulates a differential pressure ΔPₚᵣᵥ corresponding to a difference between the hydrogen pressure P_{accu} in the hydrogen accumulator 4 and the hydrogen pressure P_{u/s} upstream of the metering member 5, particularly according to the command applied to the pressure relief valve;
   the hydrogen pressure P_{accu} in the hydrogen accumulator 4 varies according to the command applied to the pressurization member 2, for example by varying the rotational speed of the pump(s) as the pressurization member 2; and
   the hydrogen pressure P_{d/s} downstream of the fixed cross-section as the metering member 5 varies according to the evolution of the pressure Pcc in the combustion chamber, for example by varying a rotational speed of a high-pressure compressor of the turbine engine.

Thus, ΔPₚᵣᵥ=P_{accu}−P_{u/s} is the head loss regulated by the pressure relief valve of the metering member 5.

The turbine engine hydrogen supply system A includes the upstream part of the hydrogen supply system A located upstream of the hydrogen accumulator 4 and a downstream part of the hydrogen supply system A located downstream of the hydrogen accumulator 4.

The upstream part of the hydrogen supply system A includes the pressurization member 2 and the heating member 3, as the member for evaporating hydrogen, particularly liquid hydrogen.

The downstream part of the hydrogen supply system A includes the metering member 5 and the shut-off member 6.

FIG. 2 illustrates graphs showing evolutions over time of the hydrogen flow rate at the output of the hydrogen accumulator 4 of the hydrogen supply system A according to the invention.

More specifically, the graphs of FIG. 2 show the evolutions over time of the hydrogen flow rate at the output of the hydrogen accumulator 4 injected into the combustion chamber of the turbine engine and the hydrogen pressure upstream of the metering member 5 of the turbine engine hydrogen supply system A in the case of a fixed flow rate at the input of the hydrogen accumulator 4, according to one embodiment of the invention.

In particular, the hydrogen accumulator 4 makes it possible to uncouple the dynamics of the upstream part of the hydrogen supply system A from the downstream part of the hydrogen supply system A.

The top part of FIG. 2 shows an example of evolution over time of the hydrogen flow rate injected into the combustion chamber. The bottom part of FIG. 2 shows a corresponding evolution over time of the hydrogen pressure P_{u/s}, upstream of the metering member 5.

It is assumed that the hydrogen flow rate injected into the combustion chamber is constant.

In a first step, the injected hydrogen flow rate equals a first hydrogen flow rate value Q₁ that is constant up to a first time t₁ then increases to a second hydrogen flow rate value Q₂ greater than the first hydrogen flow rate value Q₁.

From a second time t₂ after the first time t₁, the hydrogen flow rate injected into the combustion chamber is constant and equals the second hydrogen flow rate value Q₂.

It is also assumed that the hydrogen pressure P_{u/s} upstream of the metering member 5 is constant.

In a first step, the hydrogen pressure P_{u/s} equals a first hydrogen pressure value P_{u/s1} until the first time t₁, then decreases to a second hydrogen pressure value P_{u/s2} less than the first hydrogen pressure value P_{u/s1}.

From a third time t₃ after the first time t₁ and the second time t₂, the hydrogen pressure P_{u/s} upstream of the metering member 5 is constant and equals the second hydrogen pressure value P_{u/s2}.

Thus, following an increase in the hydrogen flow rate injected into the combustion chamber, the hydrogen pressure P_{u/s} upstream of the metering member 5 decreases with a certain inertia depending on the volume of the hydrogen accumulator 4. Such inertia increases with the volume of the hydrogen accumulator 4.

Conversely, if the hydrogen flow injected into the combustion chamber decreases, the hydrogen pressure P_{u/s} upstream of the metering member 5 increases with the same inertia.

The bottom part of FIG. 2 shows two curves of evolution over time of the hydrogen pressure P_{u/s} upstream of the metering member 5. The solid-line curve is characteristic of the evolution over time of the hydrogen pressure P_{u/s} upstream of the metering member 5, in the case where the hydrogen accumulator 4 is of reduced volume. The dashed curve is characteristic of the evolution over time of the hydrogen pressure P_{u/s} upstream of the metering member 5, in the case where the hydrogen accumulator 4 is of large volume.

For example, the volume of the hydrogen accumulator 4 is chosen such that the dynamics of variation of the hydrogen pressure P_{u/s} upstream of the metering member are slower than the dynamics of the hydrogen flow rate injected into the combustion chamber. In particular, the volume of the hydrogen accumulator 4 is chosen such that the dynamics of variation of the hydrogen pressure P_{u/s} are 5 to 10 times slower than the dynamics of the hydrogen flow rate injected into the combustion chamber.

Thus, the volume of the hydrogen accumulator 4 is chosen such that the pressure variation is slower, particularly 5 to 10 times slower, than the desired dynamics, i.e. a response time, of the metering function of the hydrogen flow rate injected into the combustion chamber.

It is then possible to uncouple the respective control logics of the upstream part and downstream part of the turbine engine hydrogen supply system A, as will be described hereinafter.

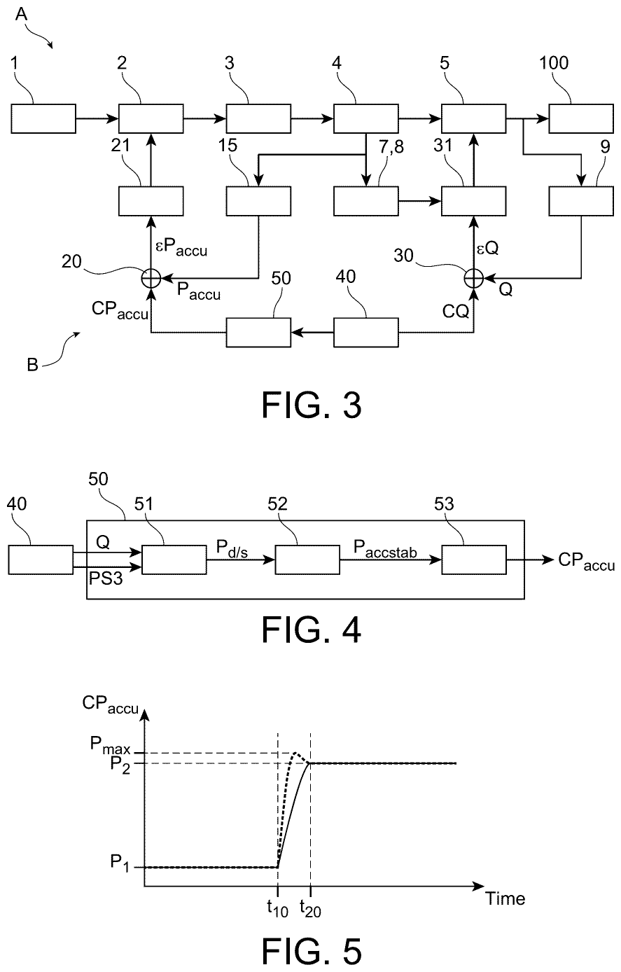

FIG. 3 schematically represents one embodiment of a regulation device B of the turbine engine hydrogen supply system A.

The regulation device B of the hydrogen supply system A includes regulation loops making it possible to uncouple the respective control logics of the upstream part and the downstream part of the turbine engine hydrogen supply system A.

To this end, a first regulation loop is a closed loop including a pressure sensor 15 capable of measuring the hydrogen pressure in the hydrogen accumulator 4. Such a pressure sensor 15 can be the hydrogen pressure sensor 8, particularly arranged upstream of the metering member 5, in particular between the hydrogen accumulator 4 and the metering member 5.

However, it is essential that the pressure sensor 15, capable of measuring the hydrogen pressure in the hydrogen accumulator 4, is as close as possible to the hydrogen accumulator 4.

The pressure sensor 15 is connected to an input of a subtracter 20, in particular a first subtracter 20. The subtracter 20 receives a value of the hydrogen pressure P_{accu} in the hydrogen accumulator 4 measured by the pressure sensor 15 as an input.

The subtracter 20 also receives a hydrogen pressure setpoint value CP_{accu} in the hydrogen accumulator 4 as an input. A determination of the hydrogen pressure setpoint CP_{accu} in the hydrogen accumulator 4 will be described hereinafter.

The subtracter 20 computes the difference between the hydrogen pressure value P_{accu} and the hydrogen pressure setpoint value CP_{accu} received. This difference represents a hydrogen pressure error εP_{accu} in the hydrogen accumulator 4.

The subtracter 20 is connected to an input of a first regulator 21, such as a pressure regulator, and supplies it with the difference between the hydrogen pressure P_{accu} and the hydrogen pressure setpoint CP_{accu} in the hydrogen accumulator 4, i.e. the hydrogen pressure error εP_{accu} in the hydrogen accumulator 4.

The first regulator 21 controls the pressurization member 2 according to the hydrogen pressure error εP_{accu} in the hydrogen accumulator 4.

The first controller 21 is, for example, a PID (acronym standing for “Proportional, Integral, Derivative”) type corrector, intended to be configured to make the pressure error εP_{accu} minimal, advantageously zero, via the control of the pressurization member 2.

In such a configuration, the first regulator 21 slaves the hydrogen pressure P_{accu} in the hydrogen accumulator 4.

A second regulation loop is a closed loop including the hydrogen flow rate sensor 9.

The hydrogen flow rate sensor 9 is connected to an input of a subtracter 30, in particular a second subtracter 30. The subtracter 30 receives a value of the hydrogen flow rate supplied to the injectors 100, measured by the hydrogen flow rate sensor 9, as an input.

The subtracter 30 also receives a hydrogen flow rate setpoint value CQ to be injected into the combustion chamber as an input. The hydrogen flow rate setpoint CQ is supplied by an engine control device 40.

The subtracter 30 computes the difference between the hydrogen flow rate value supplied to the injectors 100 and the hydrogen flow rate setpoint value CQ received. This difference represents an error in the hydrogen flow rate EQ injected into the combustion chamber.

The subtracter 30 is connected to an input of a second regulator 31, such as a flow rate regulator, and supplies it with the difference between the hydrogen flow rate injected into the combustion chamber and the hydrogen flow rate setpoint CQ in the combustion chamber, i.e. the hydrogen flow rate error EQ injected into the combustion chamber.

The second regulator 31 controls the operation of the metering member 5 according to the hydrogen flow rate error EQ injected into the combustion chamber.

The second regulator 31 is for example a PID type corrector intended to be configured to make the flow rate error EQ minimal, advantageously zero, via the control of the metering member 5.

In the case of sonic metering, gains of the second regulator 31 are determined according to the pressure and temperature measurements in the hydrogen accumulator 4, supplied by the hydrogen temperature sensor 7 and the hydrogen pressure sensor 8.

In the case of subsonic metering, the hydrogen pressure downstream of the metering member 5 is measured by a pressure measurement sensor, particularly by the hydrogen pressure sensor 8, and taken into account in the determination of the gains of the second regulator 31.

Alternatively, the temperature is not taken into account in the determination of the gains of the second regulator 31.

The second regulator 31 thus controls the metering member 5 by slaving the hydrogen flow rate injected into the combustion chamber.

As disclosed hereinabove, the engine control device 40 of the turbine engine is connected to the subtracter 30 and supplies it with the hydrogen flow rate setpoint value CQ to be injected into the combustion chamber.

The engine control device 40 of the turbine engine is also connected to a pressure setpoint processing circuit 50 capable of determining the hydrogen pressure CP_{accu} in the hydrogen accumulator 4 and supplies it with engine data.

FIG. 4 illustrates one embodiment of the pressure setpoint processing circuit 50 of the hydrogen pressure CP_{accu} in the hydrogen accumulator 4 of the hydrogen supply system A according to the invention.

More particularly, as disclosed hereinabove, the pressure setpoint processing circuit 50 of the hydrogen pressure setpoint CP_{accu} in the hydrogen accumulator 4 is integrated in the regulation device B of the turbine engine hydrogen supply system A.

The pressure setpoint processing circuit 50 comprises an input connected to the engine control device 40 of the turbine engine and an output connected to the first subtracter 20 intended to compute the difference between the hydrogen pressure value P_{accu} and the hydrogen pressure setpoint value CP_{accu}.

The pressure setpoint processing circuit 50 includes a downstream pressure processing module 51, capable of determining the hydrogen pressure P_{d/s} downstream of the metering member 5, as will be described hereinafter.

To this end, the downstream pressure processing module 51 receives the hydrogen flow rate value Q injected into the combustion chamber and a hydrogen pressure value PS3 in the combustion chamber of the engine, which are transmitted from the engine control device 40.

Taking into account a worst-case specification of the head losses ΔP_{injector} of the injectors 100, the downstream hydrogen pressure P_{d/s} is then equal to the hydrogen pressure value PS3 added to the head losses ΔP_{injectors} of the injectors 100.

Thus, the hydrogen pressure P_{d/s} is determined from the hydrogen pressure PS3 in the combustion chamber by a relation (2):

P_{d/s}=PS3+ΔP_{injectors}=PS3+f(Q) (2)

It should be noted that in the case where other items of equipment of the hydrogen supply system A, such as the shut-off member 6, are located between the metering member 5 and the injectors 100, a worst-case specification of the head losses of these items of equipment can also be taken into account in the determination of the hydrogen pressure P_{d/s}.

Alternatively, the measurement of the hydrogen flow rate Q through the metering member 5 can be replaced by a flow rate setpoint processed by the engine control device 40.

The downstream pressure processing module 51 has an output connected to an input of a stabilized setpoint processing module 52 capable of determining a stabilized hydrogen pressure setpoint CP_{accustab} in the hydrogen accumulator 4.

To this end, as detailed hereinabove, the downstream pressure processing module 51 supplies the downstream hydrogen pressure value P_{d/s} to the stabilized setpoint processing module 52.

In order to ensure sonic metering, in the stabilized state, the hydrogen pressure P_{accu} in the hydrogen accumulator 4 corresponds to the hydrogen pressure P_{u/s} upstream of the metering member 5. Advantageously, the hydrogen pressure P_{accu} in the hydrogen accumulator 4 is at least two times greater than the hydrogen pressure P_{d/s} downstream of the metering member 5.

In such a case of sonic metering, in the stabilized state, the stabilized hydrogen pressure setpoint CP_{accustab} in the hydrogen accumulator 4 must comply with a relation (3):

CP_{accustab}≥2×P_{d/s}, or

CP_{accustab}≥2×(PS3+f(Q)) (3)

In the case of subsonic metering, in the stabilized state, the stabilized hydrogen pressure setpoint CP_{accustab} in the hydrogen accumulator 4 must comply with a relation (3a):

CP_{accustab}≥P_{d/s}, or

CP_{accustab}≥PS3+f(Q) (3a)

Subsonic metering makes it possible to:
reduce needs for pressure gradients requested from the pressurization member 2, by the first regulator 21, to follow the stabilized hydrogen pressure setpoint CP_{accustab} in the transient state; and
reduce pressure needs in the stabilized state resulting in optimization of the sizing of the equipment of the pressurization member 2. It is thus possible to reduce the pressure constraints on the sizing of the equipment between the pressurization member 2 and the metering member 5.

Alternatively, the metering performed by the metering member 5 is sonic or subsonic, depending on the state of the engine and/or the turbine engine.

For example, at low engine and/or turbine engine speeds, corresponding to a low hydrogen flow rate Q, the metering is sonic. Conversely, at high engine and/or turbine engine speeds, corresponding to a high hydrogen flow rate Q, the metering is subsonic.

The switch from a sonic to subsonic metering mode and conversely is managed via the hydrogen pressure setpoint CP_{accu} regulated so as to obtain the ratio between the hydrogen pressure P_{d/s} downstream of the metering member 5 and the hydrogen pressure P_{u/s}, upstream of the metering member 5 such that
in sonic metering:

$$\frac{{P}_{d / s}}{{P}_{u / s}} < {( \frac{2}{γ + 1} )}^{\frac{γ}{γ - 1}} \approx 0.5 ( value for hydrogen ) ,$$

in subsonic metering:

$$\frac{{P}_{d / s}}{{P}_{u / s}} < {( \frac{2}{γ + 1} )}^{\frac{γ}{γ - 1}} \approx 0.5 ( value for hydrogen ) .$$

Such a variant makes it possible to:
reduce needs for pressure gradients requested from the pressurization member 2, by the first regulator 21, to follow the stabilized hydrogen pressure setpoint CP_{accustab} in the transient state;
reduce pressure needs in the stabilized state resulting in optimization of the sizing of the equipment of the pressurization member 2. It is thus possible to reduce the pressure constraints on the sizing of the equipment between the pressurization member 2 and the metering member 5; and
when the hydrogen flow rate Q at the injectors 100 is computed, having a better flow rate reconstitution precision for low hydrogen flow rates Q at injection, particularly during a start-up phase.

The downstream pressure processing module 52 has an output connected to an input of a phase lead determination module 53 capable of defining a compensation of a response time of the first regulator 21 in the transient state. The downstream pressure processing module 52 supplies the stabilized hydrogen pressure setpoint value CP_{accustab} in the hydrogen accumulator 4 to the phase lead determination module 53.

Indeed, the first regulator 21 has a response time T₂₁. Thus, in order to comply with the relation (3) in the transient state, despite the response time T₂₁ of the first regulator 21, it is necessary to compensate the response time of the first regulator 21 in the transient state. A phase lead is thus determined by the function:

H(P)=1+τ₂₁·P

FIG. 5 illustrates graphs representing an evolution over time of the hydrogen pressure setpoint CP_{accu} in the hydrogen accumulator 4 of the hydrogen supply system A, in particular during a change of state.

The change of state is characterized by a modification in the hydrogen pressure setpoint CP_{accu} in the hydrogen accumulator 4 from a first value P₁, corresponding to a first stabilized state, to a second value P₂, in the example described greater than the first value P₁, corresponding to a second stabilized state.

The switch from the first value P₁ of the hydrogen pressure setpoint CP_{accu} to the second value P₂ is carried out between a first time t₁₀ and a second time t₂₀ delimiting a transient state period between the first stabilized state, ending at the first time t₁₀, and the second stabilized state, starting at the second time t₂₀.

During the transient state, i.e. between the first time t₁₀ and the second time t₂₀, the hydrogen pressure setpoint CP_{accu} in the hydrogen accumulator 4 increases from the first value P₁ to a maximum value Pmax greater than the second value P₂ then decreases to the second value P₂.

1. A device for regulating a hydrogen supply system of a turbine engine comprising a combustion chamber, the hydrogen supply system including, particularly arranged in series, at least:
a pressurization member,
a metering member advantageously connected to the combustion chamber,
a hydrogen accumulator arranged between the pressurization member and the metering member,
a first regulator capable of controlling the pressurization member according to a hydrogen pressure in the hydrogen accumulator and a hydrogen pressure setpoint in the hydrogen accumulator, and
a second regulator capable of controlling the metering member according to a hydrogen flow rate injected into the combustion chamber and a hydrogen flow rate setpoint to be injected into the combustion chamber.

2. The regulation device according to claim 1, wherein the first regulator controls the operation of the pressurization member according to a difference between the hydrogen pressure in the hydrogen accumulator and the hydrogen pressure setpoint in the hydrogen accumulator.

3. The regulation device according to claim 1, wherein the second regulator controls the operation of the metering member according to a difference between the hydrogen flow rate injected into the combustion chamber and the hydrogen flow rate setpoint to be injected into the combustion chamber.

4. The regulation device according to claim 1, further including a pressure setpoint processing circuit capable of determining the hydrogen pressure setpoint.

5. The regulation device according to claim 4, wherein the pressure setpoint processing circuit comprises an input connected to an engine control device of the turbine engine and an output connected to a first subtracter intended to compute the difference between the hydrogen pressure value and the hydrogen pressure setpoint.

6. The regulation device according to claim 4, wherein the pressure setpoint processing circuit comprises a downstream pressure processing module capable of determining a hydrogen pressure downstream of the metering member.

7. The regulation device according to claim 6, wherein the downstream pressure processing module determines the hydrogen pressure downstream of the metering member based on the hydrogen flow rate value injected into the combustion chamber and a hydrogen pressure value in the combustion chamber.

8. The regulation device according to claim 6, wherein the pressure setpoint processing circuit comprises a stabilized setpoint processing module capable of determining a stabilized hydrogen pressure setpoint in the hydrogen accumulator.

9. The regulation device according to claim 6, wherein the pressure setpoint processing circuit comprises a phase lead determination module capable of defining a compensation of a response time of the first regulator in the transient state.

10. The regulation device according to claim 1, wherein the metering member carries out sonic and/or subsonic metering, according to the hydrogen pressure setpoint.

11. A turbine engine hydrogen supply system, the regulation device according to claim 1.

12. A turbine engine including injectors, including the hydrogen supply system according to claim 11.

13. An aircraft including the turbine engine according to claim 12.
